(19) United States
(12) Patent Application Publication
(10) Pub. No.: US 2005/0138858 A1
(43) Pub. Date: Jun. 30, 2005

(54) Trap for crawling insects

(76) Inventor: William Arthur Lyng, Wickenburg, AZ (US)

Correspondence Address: Peter A. Borsari, 3 South Fieldway, Rehoboth Beach, DE, 19971, US

(21) Appl. No.: 11/026,795

(22) Filed: Dec. 31, 2004

Related U.S. Application Data
(60) Provisional application No. 60/533,608, filed on Dec. 31, 2003.

(51) Int. Cl. A01M 1/10

(52) U.S. Cl. 43/121

(57) ABSTRACT

An insect trap constructed in the form of a box having an open front end and a removable top. Disposed within the box is a ramp having an upwardly rising domain and a downwardly declining domain, the rising domain being disposed at an angle of between 125° and 165° from the declining domain. The box, removable top and ramp elements are fabricated from a material which provides a smooth and slippery surface. A traction-providing substrate is disposed over the rising domain of the ramp, thereby enabling insects to contact and crawl up the rising domain. In operation, insects enter the open front end of the box, crawl up the rising domain, slide down the declining domain and drop to the floor of the box where the insects remain trapped.

### RELATED APPLICATIONS

This application claims the benefit of priority of U.S. Patent Provisional Application Ser. No. 60/533,608, filed in the United States Patent & Trademark Office on Dec. 31, 2003.

### FIELD OF INVENTION

The present invention relates to the field of devices which trap and contain insects for the purpose of removing pernicious insects infesting a space, and/or for collecting bait with which to feed or lure predatory animals. More specifically, the present invention relates to a trap constructed in the form of an open box into which crawling insects may enter but from which they may not exit readily.

### BACKGROUND OF THE INVENTION

Crawling insects, including crickets, centipedes, whitefish, cockroaches and the like, while serving acknowledged ecological roles within the biosphere, can be invasive and unwanted species infesting dwellings, workplaces and support buildings. The elimination of such pests within such buildings has been attempted by physical, chemical and combined means since antiquity. Of the chemical means, poisonous compounds have been widely used to kill the unwanted pests. Modern innovations have included the use of traps incorporating olfactory lures in attempts to take advantage of the chemical and pheromonal language to which these insects respond. However, the use of such lures may be objectionable to some users who may be sensitive to the musty odors of insect pheromones or who may have an allergic intolerance to chemical lures and toxins. As insects caught in such traps dies and decay, further objectionable odors may be produced. Traps incorporating toxic compounds may have restricted use in certain areas and are often banned from areas in which food preparation areas.

The prior art is replete with innovations designed to eradicate insect pests. The well-known roach trap devices have been designed which utilize a tray of adhesive to which an insect such as a roach may become permanently attached. Although highly effective at killing insects, these traps are indiscriminate and pet animals similarly may be adhered thereto through inadvertence and curiosity. U.S. Pat. No. 4,208,828 issued Jun. 24, 1980 to H. Hedley Hall et al. shows a roach trap comprising a box having a raised entrance at one end, a ramp leading into the entrance and a passageway “tube” inside the box aligned with the entrance. The passageway tube terminates above the floor of the box on which a sticky removable surface is overlain. U.S. Patent Application Publication 2002/0104255 published Aug. 8, 2002 to Graham Hobson provides another trap for crawling insects which includes a sticky surface to entrap insects.

Other types of insect traps propose certain geometrical designs to inhibit the insect from exiting the trap. For example, U.S. Pat. No. 3,908,302 issued Sep. 30, 1975 to Richard V. Carr discloses a roach trap in the form of a rectangular box-shaped housing having entranceways of a pyramid-shaped configuration which attracts cockroaches. The pyramidal openings provide their own ramps into openings dimensioned to the torso width of the cockroach. Having entered into the box, the cockroach's anatomy prevents the insect's escape, since the roach is unable to navigate the 180-degree turn over the edge of the opening back into the entranceway. The specific geometry of this box and the anatomy of the cockroach make this trap function.

U.S. Pat. No. 1,209,993 issued Dec. 25, 1916 to Edward Oettinger shows a similarly configured box wherein the opening of the trap is provided with numerous thin, tissue-like flexible strips which are freely interlaced. The interlacement of these strips serves to block an insect's approach to the entrance from the interior of the box.

U.S. Pat. No. 1,499,222 issued Jun. 24, 1924 to Isabel O. Kiley discloses a trap that has a receptacle, an opening and an attaching flange in the form of a conical tube disposed at an entrance end. The flange is attached to a clamping plate with a closure member. An insect entering the trap via the attaching flange must fall or jump from the attaching flange. The dimensions and positioning of the attaching flange prevent the insect from exiting the receptacle. A similar, more complex trap is shown in U.S. Pat. No. 1,971,640 issued Aug. 28, 1934 to William J. Cameron which illustrates a box trap having screened ends, the box being partitioned into front and rear compartments with an opening connecting the two compartments. An opening in one compartment permits entrance by an animal into a tubular runway which terminates within the compartment at a cylinder of wire netting having open ends. The cylinder supports the runway and is a barrier to insects which might try to return to the runway. An olfactory lure may be placed within the other compartment to amplify the attractiveness of this trap to insects.

U.S. Pat. No. 400,460 issued Apr. 2, 1889 to Charles G. Jennings shows a basic insect trap which is a box having a top opening over which surface Zones B and C hang. An insect may walk upon the exterior surface of the box as well as over Zone B which immediately overhangs the edges of the box; however, Zone C is polished so that the insect will slip into the box. Once within the box, the insect (non-flying) is unable to exit since it is unable to cross back over Zone C.

Despite improvements and innovations of the prior art, the numerous handicaps found in these traps for crawling insects have yet to be overcome.

### SUMMARY OF THE INVENTION

Accordingly, it is an object of the present invention to provide an improved trap for crawling insects of simple and straightforward construction which is effective at luring and entrapping unwanted insect pests.

It also is an object of the present invention to provide an improved trap for crawling insects which does not require the use of objectionable chemical or pheromonal lures and which lures and traps insects by humane and effective means.

It is an additional object of the present invention to provide a trap for crawling insects which does not employ an adhesive for trapping insects, but rather, which traps insects within a box, the surface of which provides no footing for an insect which has crawled therein so that the insect cannot crawl out of the trap.

It is a further object of the present invention to provide a trap for crawling insects which may be emptied and cleaned of entrapped insects in a simple fashion.

Additional objects, advantages and novel features of the present invention will be set forth in part in the description which follows and in part will become apparent to those skilled in the art upon examination of the following specification or may be learned by practice of the invention. To the accomplishment of the above-related objects, this invention may be embodied in the forms illustrated in the accompanying drawings, attention being called to the fact, however, that the drawings merely are illustrative, and that changes may be made in the specific construction illustrated and described within the scope of the appended claims.

### BRIEF DESCRIPTION OF THE DRAWINGS

The present invention will be better understood with reference to the appended drawing sheets, wherein:

FIG. 1 is a front environmental perspective view of the trap for crawling insects of the present invention.

FIG. 2 is an exploded perspective of the trap for crawling insects of the present invention.

FIG. 3 is a side cross-sectional view taken along line 3-3 of FIG. 1 of the trap for crawling insects of the present invention.

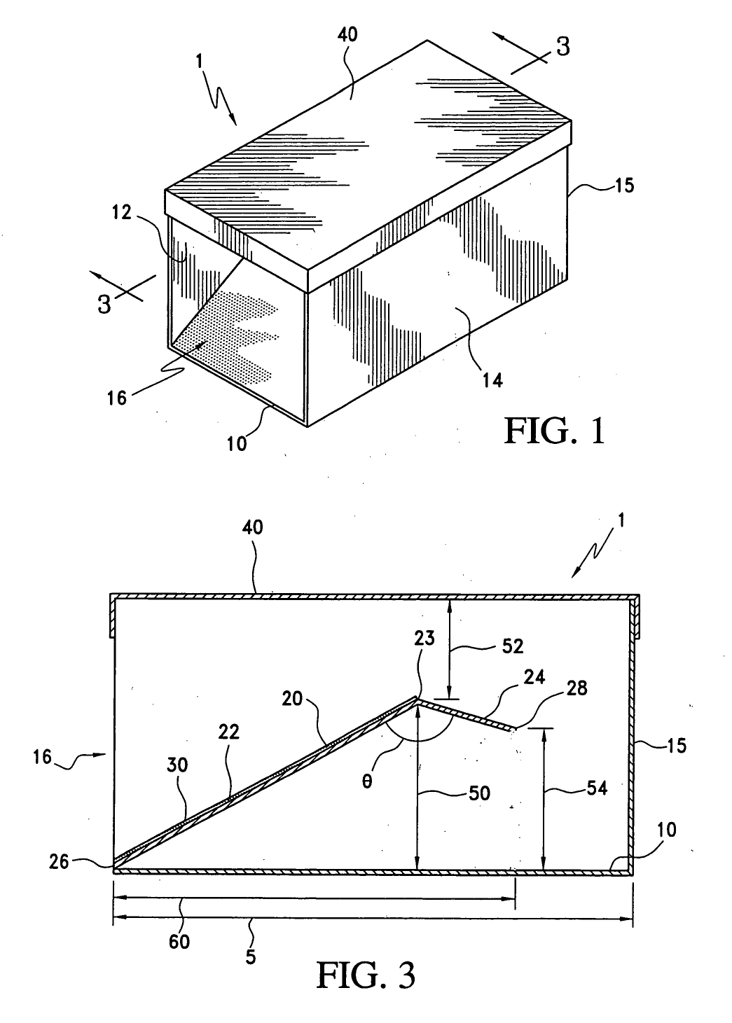

### DETAILED DESCRIPTION

Referring now to the Figures, a trap 1 for capturing crawling insects of the present invention is shown in the form of an open-ended rectangular box having an open front end 16 and being defined by a bottom wall 10, a pair of sidewalls 12, 14 and a rear wall 15 opposite the open front end. Both the sidewalls and the rear wall are integral in construction with the bottom wall, thereby forming the basic frame of a box to which a top 40 is removably attached. Each of the sidewalls 12 and 14 has a length 5 and a width 7 which correspond to the length and width of the top 40.

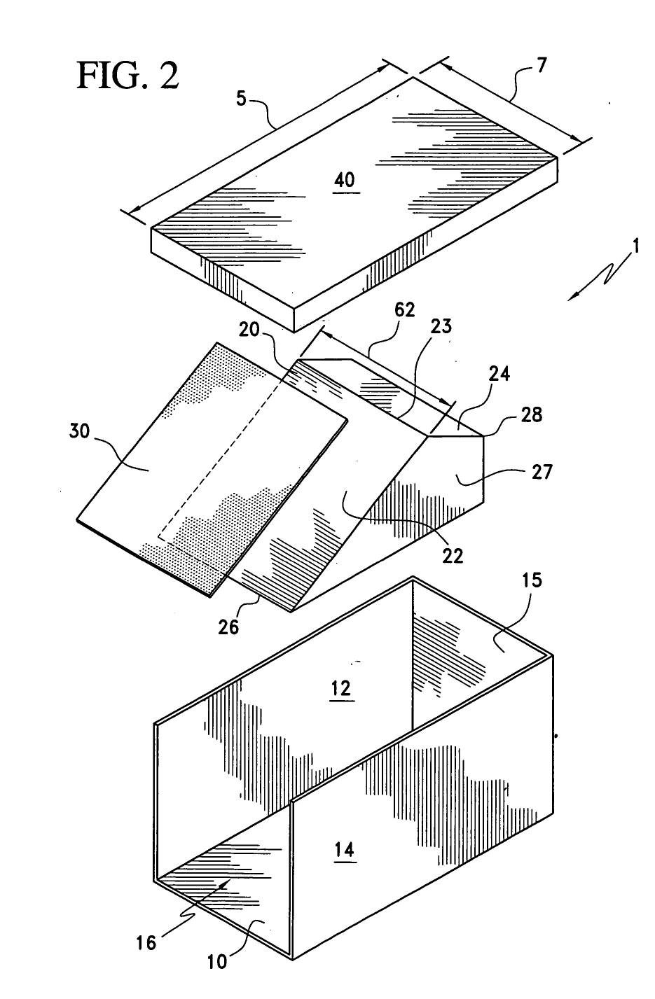

As best seen in the exploded view of FIG. 2, a ramp 20 is disposed within the box. The ramp 20 is bent to demarcate a rising domain 22 and a declining domain 24 integrally joined to one another at a bend 23. The rising domain begins at a front edge 26, positioned at the open front end 16, and rises within the trap to a first height 50 leaving a first clearance 52 measured from the top 40 at the bend 23 of the ramp 20. From this first height, the bend of the ramp allows the declining domain to terminate at a second height 54 which is lower than the first height 50. The bend 23 has an angle θ in the range of between about 125° and about 165°, preferably between about 135° and about 155°, thereby providing a relatively sharp drop of the declining domain 24.

The length 60 of the ramp 20 is shorter than the length 5 of the bottom 10, so that the terminating edge 28 of the ramp is not in contact with the rear wall 15. The width 62 of the ramp is equal to the width 7 of the bottom so that there is no gap between the ramp and the sidewalls 12 and 14 when the ramp is installed within the trap 1. This friction fitting between the ramp and the sidewalls is sufficient to secure the ramp within the trap. However, it is to be understood that other means of securing the ramp to the basic frame of the box are contemplated to be within the scope of this invention. Suitable, but non-limiting, securing means include, the use of adhesives, matching tab and slot provisions or welding. For example, the ramp can be configured with a side wing 27 at each opposing side of the ramp, such a sidewing further may be angled to exert additional pressure against the sidewalls in a friction fit. Alternatively, sidewings may be adhered to the sidewalls using any suitable adhesive or welding.

The rising domain 22 of the ramp 20 is provided with a cellulosic substrate 30 which is dimensioned to be disposed coextensively along the surface of the rising domain 22, abutting the sidewalls 12 and 14, thereby completely overlaying the rising domain 22. The cellulosic substrate has a thickness which is less than the first clearance 52 such that the remaining clearance between the top 40 and the substrate is sufficiently large to permit an insect to pass into the trap without becoming blocked between the surface of the substrate and the underside of the top.

With the exception of the cellulosic substrate 30, the individual elements of the trap 1 may be fabricated from a variety of materials, including, for example, plastics, polished metal, powder coating or non-stick polymers such as polytetrafluoroethylene (PTFE). A preferred material due to its cost and workability is polyethylene, which readily may be cast-molded or blow-molded to form the desired elements of the trap. Monomerically homologous polymers such as polypropylene and polybutylene are also highly favored. The selected material is finished to present a slick surface on which a crawling insect may not find purchase. The slick surface may be achieved directly through the molding process or through polishing after molding.

Suitable materials for the cellulosic substrate 30 include, for example, paper, cardboard and cardstock; preferably, the cellulosic substrate is composed of cardboard. When disposed upon the rising domain 22 of the ramp 20, the cellulosic substrate also is secured by friction fitting between the sidewalls. Although it is preferable that the cellulosic substrate be replaceable, permanent fixation of the substrate to the ramp may be accomplished with adhesives.

In use, the assembled trap 1 is placed in the area in which the removal of insects pests is desired. Insects such as crickets, which favor cellulosic materials as food sources, may be lured into the trap by the cellulosic substrate 30. Besides providing a lure, the cellulosic substrate provides a tractionable surface on which the lured insect can find footing. Having crawled up the rising domain 22 of the ramp 20 on the cellulosic substrate and passing over the bend 23, an insect lured into the trap will not find footing on the slick surface of the declining domain 24. Thus, the insect slides over the terminating edge 28 and onto the bottom 10 of the trap. Sidewalls 12, 14 and rear wall 15, being similarly slick, do not provide the lured insect with purchase so that the insect may not climb back onto the ramp. The gapless fitting between the ramp and the sidewalls leaves no other exits for the insect. Predator species including spiders, scorpions and the like, which may otherwise not be attracted to the cellulosic substrate 30, may be enticed to enter the trap by the odors of insects such as crickets which may already be trapped therein. When the user desires to empty the trap, he simply removes the top 40 and disposes of any insects contained therein.

Although the use of a cellulosic substrate is most preferred, other substrates providing a tractionable surface may be substituted, such as synthetic cloths, roughened plastic, substrates provided with an adhered grit and the like. Because these materials may not by themselves provide a lure for crawling insects, the may need chemical supplementation or an olfactory lure although crawling insects may yet be lured into the trap 1 which provides a darkened hiding place which itself may be attractive to pest insects.

While particular embodiments of the invention have been described, it will be understood, of course, that the invention is not limited thereto, and that many obvious modifications and variations can be made, and that such modifications and variations are intended to fall within the scope of the appended claims.

1. A trap for crawling insects comprising:
a. a box having a bottom wall, a rear wall, two parallel and opposing sidewalls, an open front end, and a removable top, said rear wall and said two opposing sidewalls being integral with said bottom wall, said open front end being disposed opposite said rear wall;
b. a ramp, said ramp comprising a rising domain having a front edge and a declining domain having a terminating edge, said rising domain being disposed at an angle θ from said declining domain, and
c. a traction-providing substrate dimensioned to coextensively overlay said rising domain of said ramp,
wherein, said ramp is positioned within said box in such a manner that said front edge of said ramp is in contact with both said open front end and said bottom wall, and said terminating edge is not in contact with said rear wall, said rising domain of said ramp extending to a first height within said box and said declining domain extending downwardly from said first height, and
wherein, both said ramp and said box are fabricated from a material which provides insufficient traction for a crawling insect to gain traction thereupon.

2. The trap for crawling insects in accordance with claim 1, wherein said traction providing substrate is a cellulosic substrate.

3. The trap for crawling insects in accordance with claim 2, wherein said cellulosic substrate is cardboard, cardstock or paper.

4. The trap for crawling insects in accordance with claim 1, wherein said angle θ is in the range of between about 125° and about 165°.

5. The trap for crawling insects in accordance with claim 1, wherein said angle θ is in the range of between about 135° and about 155°.

6. The trap for crawling insects in accordance with claim 1, wherein said box is fabricated from a plastic material.

7. The trap for crawling insects in accordance with claim 5, wherein said plastic material is polyethylene, polypropylene or polybutylene.

8. The trap for crawling insects in accordance with claim 1, wherein said box is fabricated from polytetrafluoroethylene.

9. The trap for crawling insects in accordance with claim 1, wherein said box is fabricated from polished metal.

10. The trap for crawling insects in accordance with claim 1, wherein said box is constructed by a blow molding process.

11. The trap for crawling insects in accordance with claim 1, wherein said box is fabricated by a cast molding process.

12. A method for trapping insects with the trap for crawling insects in accordance with claim 1, comprising the steps of
a. placing said trap within a space infested with undesirable pest insects, and
b. allowing said trap to remain in such space for a time period sufficient to allow one or more insects to crawl therein,
whereby one or more insects enter said trap at said open front edge in contact with said traction-providing substrate, travel up said rising domain to said first height and slide down said declining domain to said terminating edge and drop onto said bottom wall, thereby trapping one or more insects within said trap.
